(19) United States
(12) Patent Application Publication
(10) Pub. No.: US 2026/0225292 A1
(43) Pub. Date: Aug. 6, 2026

(54) Multilayer Composite Heat Shield

(71) Applicant: Zephyros, Inc., Romeo, MI (US)

(72) Inventors: Frederic Vogel, Molsheim (FR); Guillaume Klein, Molsheim (FR); Jason Walker, Romeo, MI (US)

(21) Appl. No.: 19/150,087

(22) PCT Filed: Feb. 14, 2024
(86) PCT No.: PCT/US2024/015842

§ 371 Date: Jul. 22, 2025

Related U.S. Application Data
(60) Provisional application No. 63/445,374, filed on Feb. 14, 2023.
(60) Provisional application No. 63/593,025, filed on Oct. 25, 2023.

(51) Int. Cl. B29C 44/14; B29C 44/34; B29K 63/00; B29K 105/04; B29K 105/08; B29K 309/08; B29K 705/02; B32B 3/26; B32B 5/02; B32B 5/18; B32B 5/24; B32B 15/04; B32B 15/20; B32B 27/12; B32B 27/38; B32B 27/40

(52) U.S. Cl. CPC B29C 44/145; B29C 44/3415; B32B 3/266; B32B 5/024; B32B 5/18; B32B 5/245; B32B 15/046; B32B 15/20; B32B 27/12; B32B 27/38; B32B 27/40; B29K 2063/00; B29K 2105/04; B29K 2105/0827; B29K 2309/08; B29K 2705/02; B29K 2995/0002; B29K 2995/0016; B32B 2250/03; B32B 2262/101; B32B 2307/102; B32B 2307/306; B32B 2311/24

(57) ABSTRACT

A multilayer structure comprising a first layer comprised of a resin and a fiber; a second layer comprised of a foam; and a third layer comprised of a heat reflecting material, wherein the first layer is bonded to the second layer and the second layer is bonded to the third layer.

### RELATED APPLICATIONS

This application claims the benefit of the filing dates of U.S. Provisional Application Nos. 63/445,374, filed Feb. 14, 2023, and 63/593,025, filed Oct. 25, 2023. The contents of both applications are hereby incorporated by reference herein in their entirety and for all purposes.

### TECHNICAL FIELD

The present teachings relate generally to the formation of composite multilayer structures utilizing an expanding foam. More particularly, the teachings are directed to a multilayer composite heat shield formed by at least one foamable layer.

### BACKGROUND

Exemplary past inventions that discuss and describe composite multilayer structures for use in heat shields are disclosed in U.S. Pat. Nos. 7,927,686 and 9,028,947. These references teach composite multilayer structures that utilize a variety of different materials, many of which are required for high heat applications, such as aircrafts and space crafts. Additionally, the current teachings may improve upon and/or rely upon and be related to the teachings of United States Patent Publication No. 2022/0143879, incorporated herein in its entirety for all purposes.

What is also needed is a composite multilayer structure and formation system that allows for formation within a low-pressure mold that can significantly reduce manufacturing time and materials while still meeting the heat and durability targets.

### SUMMARY OF THE INVENTION

One or more of the above needs are met by the present teachings which contemplate composite multilayer structures and methods for the manufacture of these composite multilayer structures that utilize one or more foamable layers.

The teachings herein are directed to a multilayer structure comprising: (i) a fiber and resin matrix material layer; and (ii) a foamable material layer in direct planar contact with the fiber and resin matrix material layer, the foamable material layer at least partially filling the hollow section; and (iii) a third layer of heat reflective material.

The fiber may comprise a carbon fiber.

The resin may comprise an epoxy material.

The resin may comprise a polyurethane material.

The fiber may comprise a polymeric fiber.

The foamable material layer may have a first expansion upon exposure to a first temperature and a second expansion upon exposure to a second temperature.

The second expansion may occur in a molding device.

The foamable material may be a structural foam.

The foamable material may be a sealing material.

The foamable material may be a polymeric foam.

The foamable material may comprise an epoxy resin, a phenoxy resin, a phosphate ester-based material, an acetate (e.g., EVA or EMA), an acrylate, or any combination thereof.

The fiber may comprise a polyamide fiber.

The fiber may comprise a glass fiber. The foamable material may expand upon exposure to a predetermined temperature.

The multilayer structure may be located into a mold and heated so that the foamable material expands and cures.

The resin may comprise a reformable resin material.

The resin material may be a thermoset material.

The resin material may be a thermoplastic material.

The heat reflective material may be metallic or polymeric. The multilayer structure may form a portion of a frame member.

The multilayer structure may be used as a heat shield in building component, a component in a transportation vehicle, a furniture component or a sporting good component.

The multilayer structure may form a portion of a heat shield for a battery pack for electric vehicles.

The multilayer structure may include an acoustic attenuation composite located thereon.

The multilayer structure may include a fibrous acoustic layer located in direct planar contact with the multilayer structure.

The multilayer structure may include a perforated facing sheet located in direct planar contact with the fibrous acoustic layer.

The multilayer structure may include an acoustic attenuation composite comprising a perforated facing sheet and a fibrous acoustic layer.

The fibrous acoustic layer may include a plurality of inorganic fibers.

The plurality of inorganic fibers may be selected from glass fibers, ceramic fibers, carbon fibers, or some combination thereof.

The teachings herein further include a method of forming a heat shield comprising layering a second foamable material layer onto a fiber-containing first layer; heating the second foamable material layer at a first elevated temperature to cause initial foaming; heating the second foamable material layer at a second elevated temperature to cause secondary foaming; and arranging a third heat-reflecting material layer into contact with the second foamable material layer so that the heat-reflecting material layer is adapted to be adjacent to a heat source.

The method may include forming an acoustic attenuation composite by heating one or more layers of the acoustic attention composite to form a shape that is complimentary with that of the heat shield and applying the acoustic attenuation composite to the heat shield.

The teachings herein are also directed to method of forming a heat shield comprising a step of applying a foamable material to a heat-reflecting layer using a flat stream application process.

The heat-reflecting layer may comprise an aluminum.

The foamable material may comprise a plurality of expandable microspheres.

The method may include a step of recycling any of the heat-reflecting layer that does not receive the foamable material.

### BRIEF DESCRIPTION OF THE DRAWINGS

FIG. 1 a side view of a multilayer composite in accordance with the present teachings.

FIG. 2 is a perspective view of an exemplary tool for manufacturing composites in accordance with the present teachings.

FIG. 3 is perspective views of an exemplary fibrous/resin layer in accordance with the present teachings.

FIG. 4 is perspective views of an exemplary heat reflective layer in accordance with the present teachings.

FIG. 5 is side view of an exemplary composite in accordance with the present teachings.

FIG. 6 shows the process flow for production of the composites described herein.

FIG. 7 shows a schematic view of a perforated aluminum showing a solid white section where the core material would be applied to form the part.

FIG. 8 shows a perspective view of a composite as described herein being located into a heated tool.

FIG. 9 is a close-up view of the tool and composite of FIG. 8.

FIG. 10 shows a base composite in accordance with the present teachings, prior to adding any additional layers.

FIG. 11 shows a sheet of perforated material in a heated tool in accordance with the present teachings.

FIG. 12 shows an acoustic fiber layer in accordance with the present teachings.

FIG. 13 shows an assembled composite including the base composite of FIG. 10, the perforated material of FIG. 11 and the acoustic fiber layer of FIG. 12.

### DETAILED DESCRIPTION

The present teachings meet one or more of the above needs by the improved devices and methods described herein. The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference in their entirety for all purposes. Other combinations are also possible as will be gleaned from the following claims, which are also hereby incorporated by reference in their entirety into this written description.

The composites described herein may be formed to comprise one or more fibrous/resin matrix layers (e.g., first layers), one or more foamable layers (e.g., second layers), and one or more heat reflecting layers (e.g., third layers). For simplicity of understanding, certain figures show three layers, though additional layers are possible. The composite may also be limited to three layers and substantially free of or free of any additional layers. It is contemplated that these layers can be in the above order or in an alternative order, such as third, first, and then second. The composites may include one or more resin materials and one or more fibrous materials which may be in single layer or multilayer structures. The composites may also include one or more additional layers such as adhesive or sealant layers. Such adhesive or sealant layers may be activatable (e.g., adapted to foam and/or cure upon exposure to a stimulus). The one or more adhesive or sealant layers may be activatable at ambient temperatures (e.g. at 20-22 C°) (e.g., a “foam in place” adhesive or two-part material that foams and/or cures when the two parts are mixed). Alternatively, the activatable adhesive or sealant may be activated using a stimulus (e.g., heat, moisture, chemical treatment, or the like).

The resin may be a thermoplastic or thermoset resin. The resin may include a flame retardant component. The resin may include an epoxy material. The resin may include a polyurethane material. The resin may include an acrylic material.

One or more of the layers of the multilayer composite may include one or more materials for providing vibration damping or sound attenuation (e.g., a sealing material). The sealing material may be an activatable material that expands and/or cures upon exposure to a stimulus. The layers may include adhesives, sealants, resins, or other materials.

The first layer of the composite may be formed utilizing a plurality of reinforcement fibers which may be impregnated with the resin, which may be a thermoplastic or thermoset resin. The composites may be thermoformed as a pre-preg. The pre-preg may include a thermoplastic material which may be a thermoplastic material including at least one epoxide group. The composites may be formed utilizing one or more fibrous materials, which may a lofted non-woven fibrous material, such as those described in U.S. Pat. Nos. 8,365,862; 9,033,101; 9,315,930; and 9,546,439, the contents of which are incorporated by reference herein in their entirety for all purposes. The fibrous material may be a woven material. The fibrous material may have a wicking property. The fibrous material may be used for gap filling or as matrix for a liquid resin. The fibers may be bonded together by an adhesive and/or resin material. The resin may be an acrylic resin, an epoxy resin, or any combination thereof. The composites may be formed of a thermoset material. The composites may be formed of a polyurethane material. The fibers may be in the form of a fiber mat. The fibers may be in the form of a localized fibrous insert. The fibers may be substantially homogeneously distributed throughout the resin. The fibers may be formed in a random arrangement. The composite may be substantially free of or free of any fibers.

The fiber material may form a porous surface so that the resin material can penetrate the pores in the surface so that the fiber layers become embedded in the resin. It is also possible that the foamable layers may at least partially penetrate the pores formed in the fiber/resin layers.

Where fibrous material is used it may be of any suitable fiber material and its selection will depend upon the use to which the composite material is to be put. Examples of fibrous materials that may be used include woven and non-woven textile webs such as webs derived from polyester, polyamide, polyolefin, paper, carbon and Kevlar fiber. These webs may be woven or obtained by non-woven web manufacturing techniques such as needle punching and point bonding. Metallic fibrous webs may also be used or glass fiber which may also be woven or non-woven. Other possible fibrous materials include carbon fiber and Kevlar. The fibers may include a thermoplastic component. The fibers may be formed of a thermoplastic epoxy. The fibers may include a thermoplastic epoxy fiber woven with a secondary reinforcing fiber (e.g., glass, aramid, carbon or the like). Alternatively the reinforcing fiber (e.g., glass, aramid, carbon or the like) may be coated with a thermoplastic material which may be a thermoplastic epoxy material.

The second foamable layer (which may experience foaming prior to contact with additional layers or after contact with additional layers, or may experience foaming multiple times, one or more if which may be before or after contact with addition layers) may be located adjacent one or more surface layers (e.g., fiber/resin or heat reflective/refractive layer) for forming the composite multilayer structure. The second layer may function as an insulator of heat, sound, vibration, or any combination thereof.

The foamable materials may be a rigid epoxy foam. The foam layer may be a flexible foam. Rigid is defined as hard to the touch and resistant to manually applied pressure. It may be preferred that the foam layer have a thickness of from 5 to 35 millimeters, preferably from 15 to 30 millimeters and most preferably from 20 to 25 millimeters post-foaming. In the production of the composite materials of the present teachings the foamable material from which the foam is produced may have a thickness in the unfoamed state (e.g., its green state) of from 1 to 5 millimeters, preferably 2 to 4 millimeters more preferably 2 to 3.5 millimeters. The foamable materials may expand a desired amount based on a given application. The foamable materials in a foamed state may have a thickness of about 100% greater or more than the green state thickness, about 300% greater or more than the green state thickness, or about 600% greater or more than the green state thickness. The foamable materials in a foamed state may have a thickness of about 1200% or less, about 1000% or less, or about 8% or less relative to a thickness in the unfoamed state. The foamable materials may undergo volumetric expansion of at least 5%, at least 50%, at least 100%, at least 500%, or even at least 1000% as compared to its green state volume.

It may be gleaned from the present teachings that a rate of expansion of the foamable materials may be tuned based on one or more components of the foamable materials. The one or more components of the foamable materials may be a blowing agent. The blowing agent may be a chemical blowing agent or a physical blowing agent. For example, the foamable materials may include a blowing agent such as expandable microspheres that may be configured to expand at a given temperature. The expandable microspheres may expand at a temperature of about 100° C. or more, about 150° C. or more, or about 200° C. or more. The expandable microspheres may expand at a temperature of about 400° C. or less, about 300° C. or less, or about 250° C. or less. The activation temperature for the foamable materials (e.g., the expandable microspheres of the blowing agent) may be determined by selecting different grades of blowing agents (e.g., by selecting different grades of expandable microspheres). The foamable material may include two or more different blowing agents.

The foamable materials may undergo a single expansion or may undergo multiple expansions. The foamable materials may be foamed to a first percent expansion, contacted with a fiber and/or fiber/resin matrix layer and then located into a mold where the foam expands to a second percent expansion. The first percent expansion may be greater than the second percent expansion. The second percent expansion may be greater than the first percent expansion.

It is possible that the fiber surface layers are coated (e.g., impregnated) with a resin material to form a fiber/resin matrix material. The matrix layers may then be contacted with one or more foamable layers to form a hollow composite that can be molded without need for an air bladder.

The composite materials described herein may also include a fibrous layer that employ a distributed phase (e.g., a fibrous phase) and a thermoplastic polymeric material (e.g., a reformable resin, a thermoplastic reaction product having at least one epoxide group). This type of thermoplastic material offers the benefit of mechanical properties typically achieved through the use of thermoset polymeric materials (e.g., a thermoset epoxy material) as some or all of a matrix phase of a composite. However, the material has a number of physical attributes that make it suitable for handling, processing and/or post-useful life reclamation, recycling, and/or re-use as it may be re-heated and thereafter re-formed.

The teachings contemplate the possibility that a multilayer structure may be fabricated using the composites described herein which may include a resin material, a foamable material, or both which may each be thermoplastic or thermoset in nature. In particular, the multilayer structure may be made from a thermoplastic or thermoset material in accordance with the present teachings that is reinforced with a reinforcement phase (e.g., a fiber material). The reinforcement phase may be distributed in a matrix of the thermoplastic or thermoset material (e.g., a polyamide, a polyurethane, and epoxy, an acrylate, and/or a reformable resin material as described herein). For example, the reinforcement phase may be at least a majority (by volume) of the total resin material. It may be greater than about 60% by volume or greater than about 70% by volume. It may be below about 90% by volume, below about 80% by volume, or below about 70% by volume. Any reinforcement phase may be distributed randomly, generally uniformly, and/or in one or more predetermined locations of the part.

The ratio by weight of polymeric resin to the fibers may range from about 1:10 to about 100:1 (e.g., it may range from about 1:5 to about 10:1, about 1:3 to about 5:1, or even about 1:2 to about 2:1).

The material of the distributed phase (e.g. the fiber phase) may include an organic material, an inorganic material or a combination of each. The material may be a naturally occurring material (e.g., a rubber, a cellulose, sisal, jute, hemp, or some other naturally occurring material). It may be a synthetic material (e.g., a polymer (which may be a homopolymer, a copolymer, a terpolymer, a blend, or any combination thereof)). It may be a carbon derived material (e.g., carbon fiber, graphite, graphene, or otherwise). The distributed phase may thus include fibers selected from (organic or inorganic) mineral fibers (e.g., glass fibers, such as E-glass fibers, S-glass, B-glass or otherwise), polymeric fibers (e.g., an aramid fiber, a cellulose fiber, or otherwise), carbon fibers, metal fibers, natural fibers (e.g., derived from an agricultural source), or any combination thereof. The fiber phase may comprise a plurality of elongated fibers which may be oriented generally parallel to each other. They may be braided. They may be twisted. Collections of fibers may be woven and/or nonwoven.

The material of the distributed phase may include a plurality of fibers having a length of at least about 1 cm, 3 cm, or even 5 cm, or longer. Fibers of the distributed phase may have an average diameter of about 1 to about 50 microns (e.g., about 5 to about 25 microns). The fibers may have a suitable coating thereon. The fibers may be present in the fiber/resin layer, in an amount of at least about 20%, 30%, 40% or even 50% by weight. The fibers may be present in each layer, or in the fibrous insert generally, in an amount below about 90%, 80%, or even about 70%, by weight. By way of example, the fibers may be present in the resin/fiber layer in an amount of about 50% to about 70% by weight. Fiber contents by weight may be determined in accordance with ASTM D2584-11.

It is contemplated that the third layer functions to reflect or refract heat (thermal energy). Examples of suitable materials include metallic materials such as metal foil (or plate), aluminum or steel foil (or plate), plastic film or sheeting such as polypropylene or polyethylene film or polyethylene terephthalate film. It is contemplated that this layer may be flat, embossed, textured, perforated, or any combination of thereof. This may be used to aid in meeting the heat deflection functionality. One example of an embossed version can be seen in FIG. 4.

It is possible that the composite may include an acoustic device aligned with the composite. The acoustic device may be an additional layer or layers, distinct from the first, second, and third layer. The acoustic device could replace one of the first, second, or third layers. It is possible that this acoustic device or at least a portion of this device may also be formed in similar shape to that of the composite so that the device is complimentary in shape with the composite. The device may include one or more layers. The device may include a facing sheet layer. The facing sheet layer may be a perforated material. The facing sheet layer may be polymeric or metallic. The facing sheet layer may be aluminum. The facing layer may be a perforated aluminum. The device may also include a fibrous acoustic layer. The fibrous acoustic layer may be woven or non-woven. The fibrous acoustic layer may include inorganic or organic fibers. The fibrous acoustic layer may include a combination of inorganic and organic fibers. The inorganic fibers may be selected from carbon, glass, ceramic, and basalt. The organic fibers may be selected from cotton, wool, hemp, and flax. The fibers may be bicomponent fibers. The fibrous acoustic layer may be substantially free of organic fibers.

The resulting composites may exhibit one or any combination of the following characteristics: a tensile strength at yield (according to ASTM D638-14) of at least about 15 MPa (e.g., at least about 30 MPa or 45 MPa), a tensile elongation strength at break (according to ASTM D638-14) of at least about 40 MPa (e.g., at least about 45 or 55 MPa); an elongation at break (according to ASTM D638-14) of at least about 15% (e.g., at least about 20%, 25 or 30%); and/or a tensile modulus of elasticity (according to ASTM D638-14) of at least about 0.5 GPa, (e.g., at least about 1 GPa, 1.8 GPa, or 2.7 GPa).

The resulting composites may have a predetermined shape. The shape may include one or more elongated portions. The multilayer structure may include a plurality of portions each having a different shape. The multilayer structure may be configured to define a heat shield, which optionally may be supported by an underlying multilayer structure. The multilayer structure may be configured to define a support that underlies a heat shield. The composite may have a substantially planar portion. The composite may have one or more curved surfaces.

The composites may be formed using a variety of methods. The method may include a step of at least partially shaping the composite multilayer structure. For example, a tool may be preheated to a temperature above the softening temperature and/or the melting temperature of a polymer of at least one of the composite layers prior to placing the layer or layers in the cavity of the tool. Pressure that results from expansion of the foamable layers may be suitable to push the surface layers out to the wall of the mold, eliminating the need for any air bladder or complex injection molding devices.

The method may include a step of compounding the second layer (e.g., foamable) layer, followed by a flat stream application of the foamable material layer and/or fibrous layer onto a heat reflective layer. The process may further include locating the layers into a heated tool to cause expansion and cure of the foamable material followed by a trimming step to finalize part shape. The resulting part is then ready for packaging.

It is contemplated that the materials as disclosed herein may be paintable. Paintability may be desirable, for example, if any surface is visibly exposed. The material may be ink jet printed. The material may be paintable, as it may have an affinity for taking paint. This may be due, at least in part, to the polarity of the material and/or the hydroxyl functionality of the backbone (e.g., generally linear backbone polymer chain) in the event that the matrix material is a reformable resin.

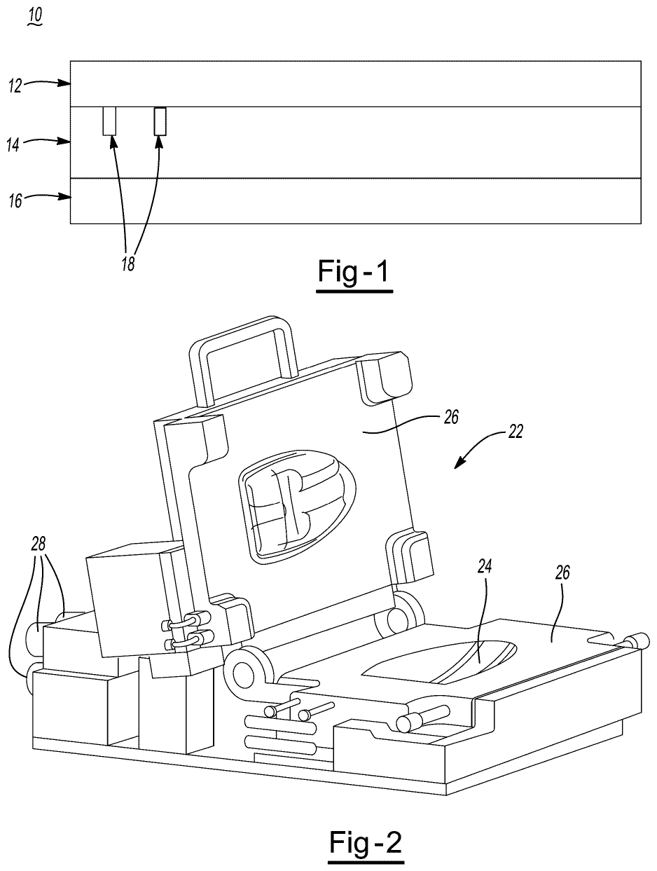

Turning now to the figures, FIG. 1 illustrates a side view of a multilayer composite heat shield 10 in accordance with the present teachings. As shown, the multilayer composite heat shield 10 may include a first layer 12, a second layer 14, and a third layer 16. However, it should be noted that the multilayer composite heat shield 10 may include one or more additional layers in between any of the layers shown in the figures.

A plurality of projections 18 may extend from one layer into another layer. The projections 18 may improve structural integrity of the composite 10. The projections 18 may also follow a desired surface of a secondary component or multilayer structure receiving the composite 10. It may also aid in the adhesion (bonding) of one layer to another layer.

### Examples

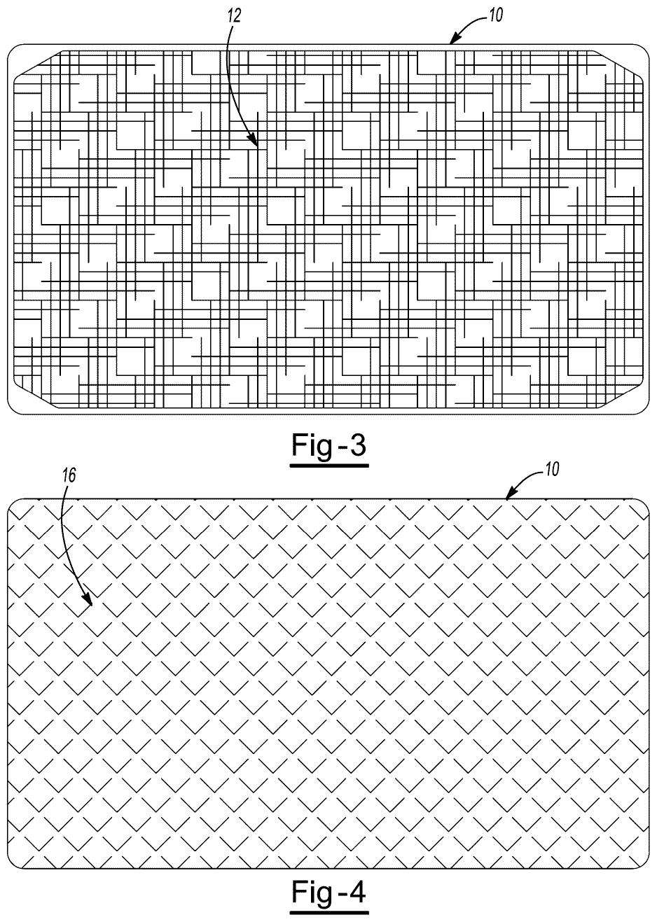

In one preferred embodiment (shown in FIGS. 3-5), the multilayer composite heat shield comprises three layers and must pass the following tests as disclosed in the table 1 and table 2 below.

Layer three is an embossed aluminum 300 μm at 800 GSM where the function of the aluminum is to pass all the constraints linked to fire and heat. It will also assist in passing tests such as high pressure cleaning. Layer two is a foam core about 0.6 mm thick before expansion. The foam core will bring structure and rigidity to the part when bonded to layer one. Layer one is a dry braided fiber glass, about 250 GSM.

TABLE 1

| | |
|---|---|
| Test Type | Heat Release measurement |
| Test Standard | ISO 5660-1: 2015 and ISO 5660-1/A1: 2019 |
| Test Procedure | MO109 H |
| Rescoll Reference | 2206689 |
| Material | Fiber with flame retardant epoxy matrix/Aluminum |
| Test conditions | Flow rate: 0.024 m³/s; |
| | Conditioning: 23 ± 2° C.; 50 ± 5% relative humidity |
| | C factor: 0.041002 |
| | Test device: RESCOLL installation COCA 1001 |
| | Heat flux: 50 kW/m² |
| | Test duration: 1800 s |
| | Cone sample separation: 25 mm |
| | Test face: aluminum |
| | Surface area: 88.4 cm² |

TABLE 2

| Test Type | Multi Impact Testing |
|---|---|
| Test Standard | DIN EN ISO 20567-1 |
| Material | Fiber with flame retardant epoxy matrix/Aluminum |
| Test | Conditioning: 23 ± 2° C.; 50 ± 5% relative humidity |
| conditions | Test Temperature: 18-28° C. |
| | Method for removing loose coating: A.1: brushed |
| | Conditioning duration: 16 hours |
| | Number of tests: 3 |
| | Test results: weight loss 1.8%, 1.5%, 1.3% - average |
| | 1.5% |

FIG. 2 illustrates a perspective view of a tool 22 for manufacturing multilayer composites 10 as illustrated in FIG. 1. The tool 22 may include a cavity 24. The cavity may be configured to receive the composite material in an uncured state. For example, the composite material in an uncured state may be pumpable so that the composite material may be pumped directly into the cavity 24. Alternatively, the composite material in an uncured state may be preformed and inserted into the cavity 24. The preformed composite material may have a size less than a size of the cavity 24 to allow for expansion of the preformed composite material. The cavity 24, tool surfaces 26 along the cavity 24, or both may be heated to cure the composite material and form a resultant composite.

It is envisioned that the cavity 24 may be rapidly heated and cooled to improve overall efficiency of the manufacturing process. For example, a temperature of the cavity 24 may be increased to a desired heating temperature and then rapidly cooled to a desired cooling temperature in a short cycle time. The cycle time may be about 30 seconds or more, about 60 seconds or more, or about 90 seconds or more. The cycle time may be about 180 seconds or less, about 150 seconds or less, or about 120 minutes or less. Accordingly, it is envisioned that the composite material may withstand rigorous and rapid changes in temperature. For example, the temperature may range from about 30° C. or more, about 50° C. or more, or about 70° C. or more to about 200° C. or more, about 250° C. or more, or about 300° C. or more. The temperature may range from about 150° C. or less, about 100° C. or less, or about 85° C. or less to about 500° C. or less, about 400° C. or less, or about 350° C. or less. As such, the composite material may expand, cure, or both very quickly during the cycle time to provide a finished composite 10. For example, the composite material may be injected into the cavity 24. Once the cavity 24 is filled with a desired amount of the composite material, the cavity 24 and/or tool surfaces 26 may be rapidly heated to expand and/or cure the composite material. The composite material may then fill substantially an entirety of the cavity 24. The cavity 24 may then be rapidly cooled, resulting in a cured and final composite 10.

It should be noted that the cavity 24 may be rapidly heated and cooled in any desired manner. However, it is envisioned that the cavity 24 may be heated rapidly via induction heating. The heating may be powered by one or more generators (not shown) electrically connected to the tool 24. The generators may power one or more desired cycle outputs (e.g., a single zone, dual zone, etc.) based on identical or different parameters to heat the cavity 24. The cycle outputs may be output simultaneously or in a varied manner. The generators may have any desired power outputs based on a given application.

The cavity 24 may also be rapidly cooled in any desired manner. However, it is envisioned that the cavity 24 may be rapidly cooled via an external cooling unit (not shown). The external cooling unit may be connected to the tool 22 via one or more ports 28. The external cooling unit may include a hydraulic module to cool the tool 22. The cooling unit may be a closed loop cooling unit or may be an open loop system. The cooling unit may use one or more liquids to rapidly cool and dissipate heat from the tool 22. For example, the cooling unit may cool the tool 22 using water being pushed through one or more channels connected to the tool 22.

It should also be noted that the cavity 24 may also include one or more additional materials to form a resulting composite 10. For example, a liner or shell may be molded in the cavity 24 first and then the composite material may be injected into the cavity 24. As such, the composite material may fill one or more voids of a shell or secondary material. Upon expanding and curing, the composite material may bond to the secondary material to form the resultant composite 10. Therefore, the composite 10 described herein may be formed in a single tool 22 free of secondary operations needed in conventional manufacturing processes. For example, the manufacturing process for the composite 10 may be free of pre-forming the composite and machining the composite to a desired shape before bonding secondary components or layers to the composite. Instead, the composite 10 may be shaped and bonded to secondary components in the same tool.

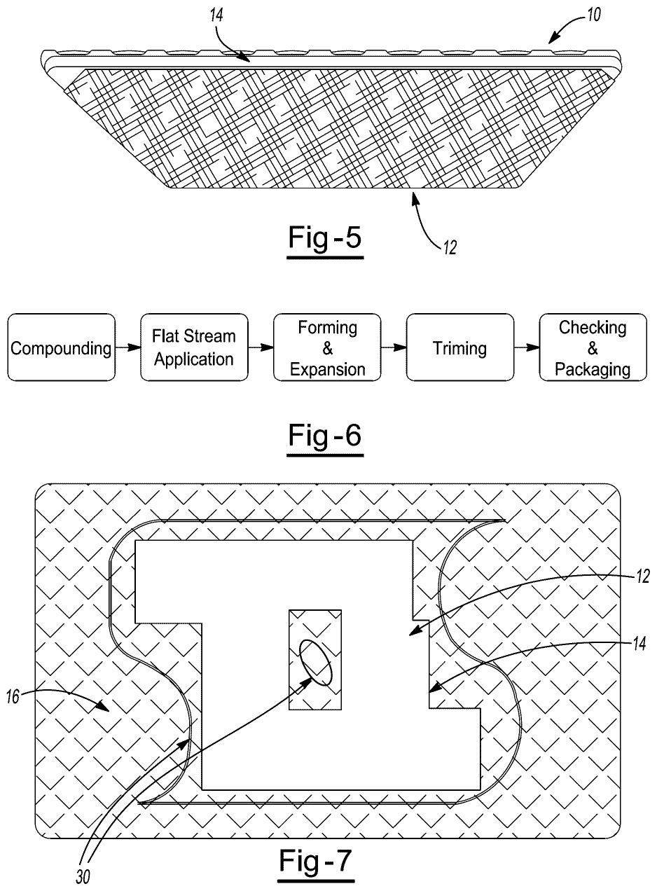

FIG. 3 shows an example fiber/matrix layer 12. FIG. 4, shows an example embossed metallic layer 16. FIG. 5 shows all three fibrous/resin matrix layer 12, foam layer 14, and heat reflective layer 16.

FIG. 6 shows a process flow diagram of an exemplary process in accordance with the teachings herein. The process includes a step of compounding the second layer (e.g., foamable) layer, followed by a flat stream application of the foamable material layer and fibrous layer onto a heat reflective layer. The process further includes locating the layers into a heated tool to cause expansion and cure of the foamable material followed by a trimming step to finalize part shape. The resulting part is then ready for packaging.

FIG. 7 shows the heat reflective layer 16 with markings to show where the first layer 12 and second layer 14 would be located onto the heat reflective layer during an application process. The outlines 30 show the intended shape of the part after being located into and formed in a tool (not shown).

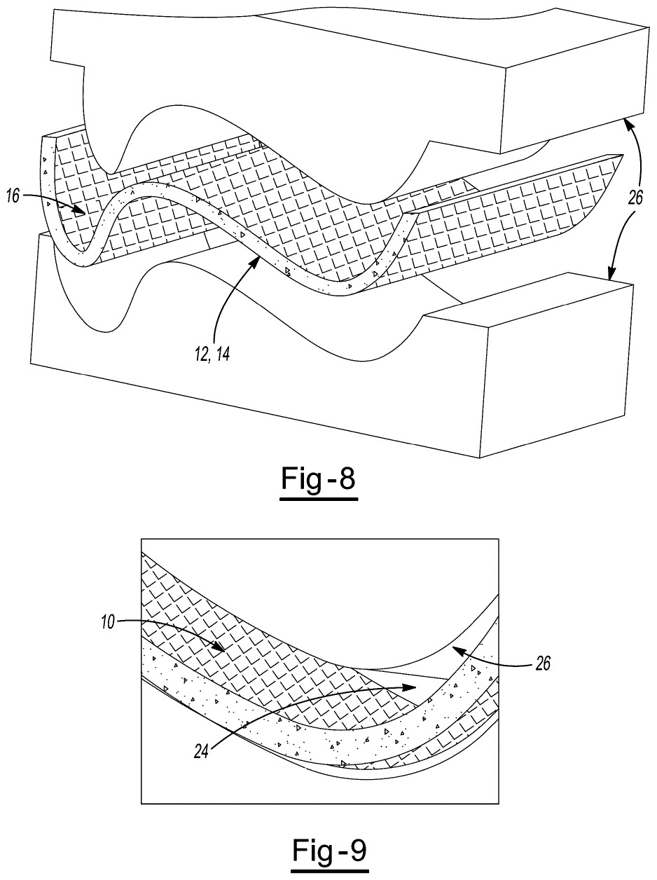

FIGS. 8 and 9 show the assembled composite 10 including the heat reflective layer 16, resin layer 12, and foam layer 14 being located into in between the tool surfaces 26. In FIG. 9 specifically the cavity 24 of the tool and surfaces 26 of the tool are shown with the composite 10 shown therebetween.

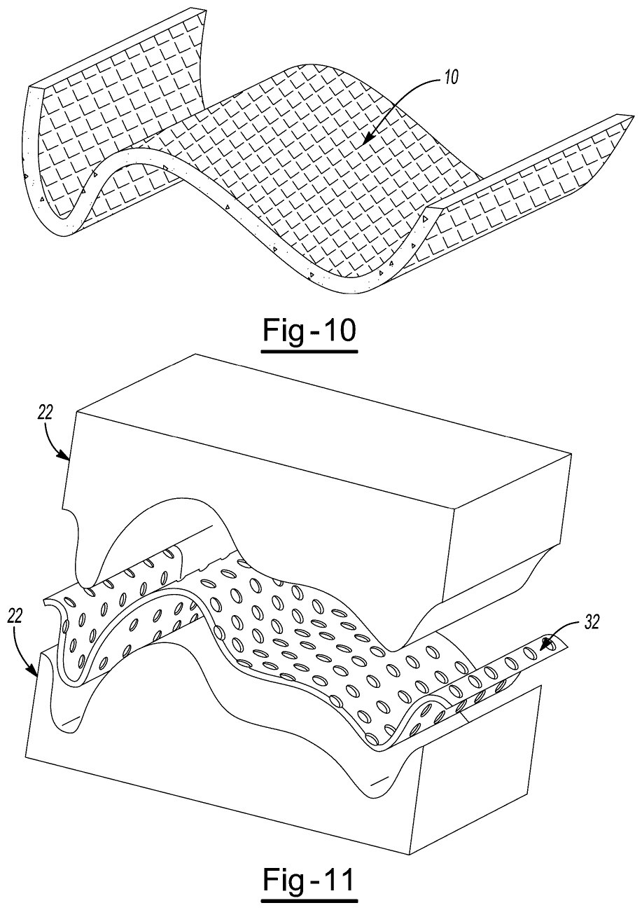

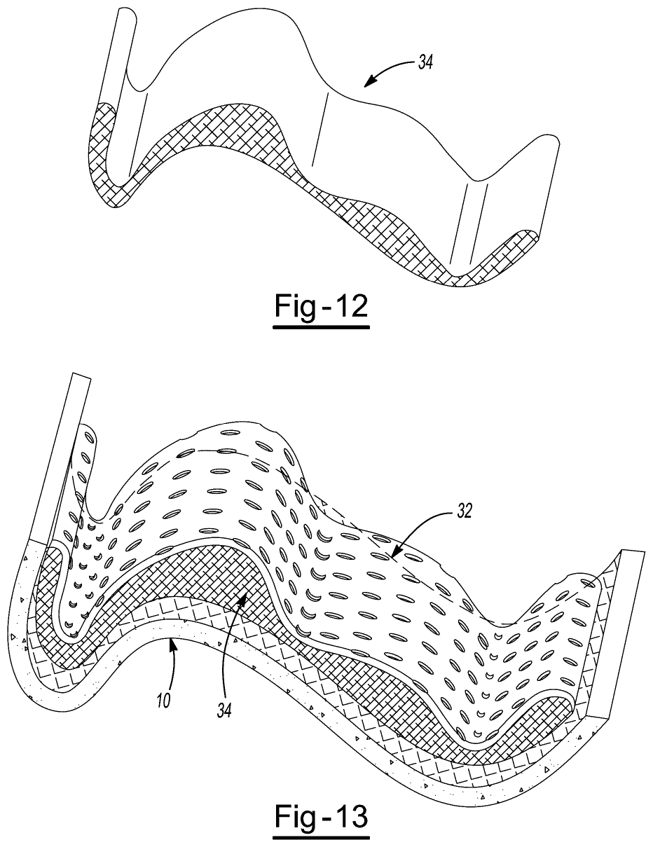

FIGS. 10, 11, 12 and 13 show an alternative embodiment that includes an additional layers for providing additional acoustic attenuation. The original multilayer composite 10 is shown in FIG. 10. A perforated facing sheet 32 is shown in a tool 22 for shaping at FIG. 11. A fibrous acoustic layer 34 is shown at FIG. 12. The entire layup of multilayer composite 10, fibrous acoustic layer 34, and perforated facing sheet 32 are shown assembled in FIG. 13.

### ELEMENT LIST

10 Multilayer Composite Heat Shield
12 First layer-fibrous/resin matrix layer
14 Second layer-foam/foamable layer
16 Third layer-heat reflective layer
18 Projections
22 Tool
24 Cavity
26 Tool Surface
28 Ports
30 Part outline
32 Perforated facing sheet
34 Fibrous acoustic layer

As used herein, unless otherwise stated, the teachings envision that any member of a genus (list) may be excluded from the genus; and/or any member of a Markush grouping may be excluded from the grouping.

Unless otherwise stated, any numerical values recited herein include all values from the lower value to the upper value in increments of one unit provided that there is a separation of at least 2 units between any lower value and any higher value. As an example, if it is stated that the amount of a component, a property, or a value of a process variable such as, for example, temperature, pressure, time and the like is, for example, from 1 to 90, preferably from 20 to 80, more preferably from 30 to 70, it is intended that intermediate range values such as (for example, 15 to 85, 22 to 68, 43 to 51, 30 to 32 etc.) are within the teachings of this specification. Likewise, individual intermediate values are also within the present teachings. For values which are less than one, one unit is considered to be 0.0001, 0.001, 0.01, or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the of a range in terms of “at least ‘x’ parts by weight of the resulting composition” also contemplates a teaching of ranges of same recited amount of “x” in percent by weight of the resulting composition.”

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for ail purposes. The term “consisting essentially of to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist of, or consist essentially of the elements, ingredients, components or steps.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

1-28. (canceled)

29. A method of forming a heat shield comprising:
(i) layering a second foamable material layer onto a fiber-containing first layer;
(ii) heating the second foamable material layer at a first elevated temperature to cause initial foaming;
(iii) heating the second foamable material layer at a second elevated temperature to cause secondary foaming;
(iv) arranging a third heat-reflecting material layer into contact with the second foamable material layer so that the heat-reflecting material layer is adapted to be adjacent to a heat source.

30. The method of claim 29, including layering an acoustic attenuation composite onto the heat shield located thereon.

31. The method of claim 29, including locating a fibrous acoustic layer in direct planar contact with the heat shield.

32. The method of claim 31, including a locating a perforated facing sheet in direct planar contact with the fibrous acoustic layer.

33. The method of claim 29, including locating an acoustic attenuation composite comprising a perforated facing sheet and a fibrous acoustic layer onto the heat shield.

34. The method of claim 31, wherein the fibrous acoustic layer includes a plurality of inorganic fibers.

35. The method of claim 34, wherein the plurality of inorganic fibers are selected from glass fibers, ceramic fibers, carbon fibers, or some combination thereof.

36. The method of claim 29, including forming an acoustic attenuation composite by heating one or more layers of the acoustic attention composite to form a shape that is complimentary with that of the heat shield and applying the acoustic attenuation composite to the heat shield.

37. (canceled)

38. The method of claim 29, wherein the heat-reflecting layer comprises an aluminum.

39. The method of claim 38, wherein the foamable material comprises a plurality of expandable microspheres.

40. The method of claim 29, including a step of recycling any of the heat-reflecting layer that does not receive the foamable material.

41. The method of claim 29, wherein the fiber-containing first layer comprises a polyurethane resin matrix material.

42. The method of claim 41, wherein the fiber-containing first layer comprises a glass fiber or carbon fiber.

43. The method of claim 29, wherein the heating steps occur in a mold.

44. The method of claim 43, including rapidly heating and rapidly cooling the mold.

45. The method of claim 43, including rapidly heating the mold by inductively heating.

46. The method of claim 43, including rapidly cooling the mold using water flowing through one or more loops in communication with the mold.

47. The method of claim 29, wherein the fiber-containing first layer comprises an epoxy resin matrix material.

48. The method of claim 29, wherein the second foamable material layer comprises an epoxy resin, a phenoxy resin, a phosphate ester, an acetate (e.g., EVA or EMA), an acrylate or any combination thereof.

49. The method of claim 29, wherein heating to the first elevated temperature occurs in a first mold and heating to a second elevated temperature occurs in a second mold.
